(19) United States
(12) Patent Application Publication
(10) Pub. No.: US 2025/0201236 A1
(43) Pub. Date: Jun. 19, 2025

(54) HIERARCHICAL RECURRENT ADAPTERS FOR EFFICIENT MULTI-TASK ADAPTATION OF LARGE SPEECH MODELS

(71) Applicant: Google LLC, Mountain View, CA (US)

(72) Inventors: Tsendsuren Munkhdalai, Pleasanton, CA (US); Khe Chai Sim, Dublin, CA (US); Tara N. Sainath, Jersey City, NJ (US); Pedro J. Moreno Mengibar, Jersey City, NJ (US)

(73) Assignee: Google LLC, Mountain View, CA (US)

(21) Appl. No.: 18/929,102

(22) Filed: Oct. 28, 2024

Related U.S. Application Data
(60) Provisional application No. 63/611,280, filed on Dec. 18, 2023.

(51) Int. Cl. G10L 15/07; G10L 15/06; G10L 15/16

(52) U.S. Cl. CPC G10L 15/07; G10L 15/063; G10L 15/16

(57) ABSTRACT

A method for implementing hierarchical recurrent adapters for efficient multi-task adaptation of large speech models including obtaining an automatic speech recognition (ASR) model pre-trained on an initial training data set, the ASR model including a plurality of layers. The method includes augmenting the ASR model with a recurrent adapter including a controller and a plurality of adapter heads, wherein the controller and the plurality of adapter heads are shared with each layer of the plurality of layers of the ASR model. The method also includes receiving an adaptation training data set including a plurality of spoken utterances, each respective spoken utterance paired with a respective transcription of the respective spoken utterance. The method includes adapting the ASR model augmented with the recurrent adapter to the adaptation training data set while parameters of the ASR model are frozen.

### CROSS-REFERENCE TO RELATED APPLICATIONS

This U.S. patent application claims priority under 35 U.S.C. § 119(e) to U.S. Provisional Application 63/611,280, filed on Dec. 18, 2023. The disclosure of this prior application is considered part of the disclosure of this application and is hereby incorporated by reference in its entirety.

### TECHNICAL FIELD

This disclosure relates to hierarchical recurrent adapters for efficient multi-task adaptation of large speech models.

### BACKGROUND

Automatic speech recognition (ASR) is a category of natural language processing (NLP) which involves processing audio containing human speech. An ASR model (or speech model) is often used to recognize and/or translate spoken language into text. One way to produce an ASR model is by using machine learning to train a model on large sets of data. Due to the amount of data that is used for training and the amount of time the training takes, ASR models are usually generalized for many domains and users, which make the models inflexible. Attempts to make ASR models more flexible, such as by using a number of smaller models, can be computationally expensive (e.g., through redundancies in training the multiple models) or provide skewed results (e.g., models with less training data will not be as robust). Further, fine-tuning a large pre-trained model to a specific task is neither practical nor scalable to multiple tasks.

### SUMMARY

One aspect of the disclosure provides a computer-implemented method for hierarchical recurrent adapters for efficient multi-task adaptation of large speech models. The computer-implemented method is executed by data processing hardware that causes the data processing hardware to perform operations including obtaining an automatic speech recognition (ASR) model pre-trained on an initial training data set, the ASR model including a plurality of layers. The operations include augmenting the ASR model with a recurrent adapter including a controller and a plurality of adapter heads, wherein the controller and the plurality of adapter heads are shared with each layer of the plurality of layers of the ASR model. The operations also include receiving an adaptation training data set including a plurality of spoken utterances, each respective spoken utterance of the plurality of spoken utterances in the adaptation training data set is paired with a respective transcription of the respective spoken utterance. The operations include adapting the ASR model augmented with the recurrent adapter to the adaptation training data set while parameters of the ASR model are frozen.

Implementations of the disclosure may include one or more of the following optional features. In some implementations, each adapter head of the plurality of adapter heads includes a simple linear projection matrix architecture and/or a feed-forward network (FFN) architecture. Each spoken utterance of the plurality of spoken utterances of the adaptation training data set may be spoken by a speaker with atypical speech. Further, a number of the plurality of spoken utterances in the adaptation training data set may be less than a number of utterances in the initial training data set used to pre-train the ASR model.

In some implementations, the initial training data set includes a set of un-transcribed speech utterances. In these implementations, the ASR model may be pre-trained on the set of un-transcribed speech utterances using BERT-based Speech pre-training with random projection quantizer (BEST-RQ). In these implementations, the speech utterances in the set of un-transcribed speech utterances may include multilingual speech utterances. The adaptation training data set may include anonymized utterances in a single language. Further, augmenting the ASR model with the recurrent adapter may further include inserting the controller and the plurality of adapter heads of the recurrent adapter into each layer of the ASR model.

Another aspect of the disclosure provides a system for hierarchical recurrent adapters for efficient multi-task adaptation of large speech models. The system includes data processing hardware and memory hardware in communication with the data processing hardware. The memory hardware stores instructions that when executed on the data processing hardware cause the data processing hardware to perform operations. The operations include obtaining an automatic speech recognition (ASR) model pre-trained on an initial training data set, the ASR model including a plurality of layers. The operations include augmenting the ASR model with a recurrent adapter including a controller and a plurality of adapter heads, wherein the controller and the plurality of adapter heads are shared with each layer of the plurality of layers of the ASR model. The operations also include receiving an adaptation training data set including a plurality of spoken utterances, each respective spoken utterance of the plurality of spoken utterances in the adaptation training data set is paired with a respective transcription of the respective spoken utterance. The operations include adapting the ASR model augmented with the recurrent adapter to the adaptation training data set while parameters of the ASR model are frozen.

This aspect may include one or more of the following optional features. In some implementations, each adapter head of the plurality of adapter heads includes a simple linear projection matrix architecture and/or a feed-forward network (FFN) architecture. Each spoken utterance of the plurality of spoken utterances of the adaptation training data set may be spoken by a speaker with atypical speech. Further, a number of the plurality of spoken utterances in the adaptation training data set may be less than a number of utterances in the initial training data set used to pre-train the ASR model.

In some implementations, the initial training data set includes a set of un-transcribed speech utterances. In these implementations, the ASR model may be pre-trained on the set of un-transcribed speech utterances using BERT-based Speech pre-training with random projection quantizer (BEST-RQ). In these implementations, the speech utterances in the set of un-transcribed speech utterances may include multilingual speech utterances. The adaptation training data set may include anonymized utterances in a single language. Further, augmenting the ASR model with the recurrent adapter may further include inserting the controller and the plurality of adapter heads of the recurrent adapter into each layer of the ASR model.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for hierarchical recurrent adapters for efficient multi-task adaptation of large speech models.

FIG. 2 is a schematic view of an example automatic speech recognition (ASR) model.

FIG. 3 is a schematic view of an example training process for pre-training a large automatic speech recognition model.

FIG. 4 is a schematic view of an example Conformer architecture implemented by an audio encoder of the automatic speech recognition model.

FIG. 5 is a schematic view of an example hierarchical recurrent adapter.

FIG. 6 is a schematic view of an example training process for a text-to-speech model configured with residual adapters

FIG. 7 a flowchart of an example arrangement of operations for a method of for hierarchical recurrent adapters for efficient multi-task adaptation of large speech models.

FIG. 8 is a schematic view of an example computing device that may be used to implement the systems and methods described herein.

Like reference symbols in the various drawings indicate like elements.

### DETAILED DESCRIPTION

Automatic speech recognition (ASR) is a growing field of language processing which has a wide variety of uses, from automatic translation and transcription of speech to processing voice commands for computing devices. Recently, neural networks for machine learning have been found to perform well as a base for ASR systems and models. Using machine learning techniques, ASR models may be trained on large sets of training data including audio samples of speech to produce a robust model for speech recognition. Generally, these ASR models are large, as the more extensively the model is trained, the better it performs. However, there are drawbacks to using such large models, such as a single model used for a wide variety of users with different characteristics. For example, a single ASR model may be built for the English language even though English speakers can have many different accents or colloquialisms based on region. In turn, the ASR model may not perform as accurately for certain groups of users. Further, it is difficult to retrain or update models due to the size because of the computational expenses. This may cause the ASR model to be out of date and not perform well for new/emerging words/phrases (e.g., slang, new TV shows).

Recently, there have been attempts to adapt a single large pre-trained ASR model to multiple downstream tasks (i.e., domains). However, full model adaptation, such as fine-tuning, is expensive as the entire model is trained for a single task. Because the per-task parameter overhead becomes as large as the entire number of weights of the model, the full-tuning approach is not scalable in applications with a large number of tasks, like personalized speech recognition.

Parameter efficient adaptation methods, on the other hand, focus on fine-tuning only a fraction of model weights (e.g., the final dense layer before softmax) or adding a small number of task specialized parameters. Parameter efficient adaptation methods for large ASR models have become a key mechanism to train large pre-trained models for downstream tasks. However, the per-task parameter overhead of these methods is considerable when the number of downstream tasks to adapt for is large. In other words, these parameter efficient adaptation methods are not easily scalable.

Implementations herein are directed to parameter efficient adapter methods for adaptation of large pre-trained speech models for automatic speech recognition (ASR) tasks. Specifically, implementations include a Hierarchical Recurrent Adapter (HRA) for efficiently adapting ASR models to perform speech recognition on multiple tasks and at large scale. The HRA may be hierarchical in terms of how parameters are allocated, meaning that the parameters are consistent through various layers of the HRA. Further, the HRA may include a single shared controller network and multiple task-level adapter heads to reduce the per-task parameter overhead without performance regression on downstream tasks. In some implementations, the HRA is recurrent such that all of the HRA parameters are reused across different layers of the pre-trained ASR model.

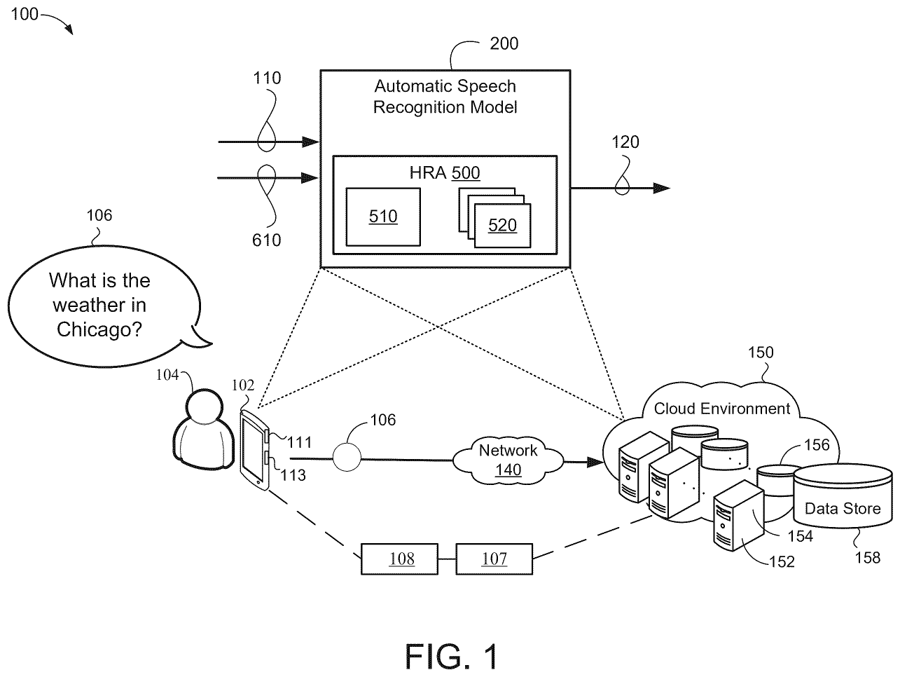

FIG. 1 illustrates a speech environment 100 implementing an ASR model 200 that resides on a user device 102 of a user 104 and/or in a cloud environment 150 (e.g., a one or more servers of a distributed system) in communication with the user device 102 through a network 140. Although the user device 102 is depicted as a mobile computing device (e.g., a smart phone), the user device 102 may correspond to any type of computing device such as, without limitation, a tablet device, a laptop/desktop computer, a wearable device, a digital assistant device, a smart speaker/display, a smart appliance, an automotive infotainment system, or an Internet-of-Things (IoT) device, and is equipped with data processing hardware 111 and memory hardware 113.

The user device 102 includes an audio subsystem 108 configured to receive an utterance 106 spoken by the user 104 (e.g., the user device 102 may include one or more microphones for recording the spoken utterance 106) and convert the utterance 106 into a corresponding digital format associated with input acoustic frames 110 capable of being processed by the ASR model 200. The input acoustic frames 110 may be interchangeably referred to as input audio data 110. While the device 102 implements a single audio subsystem 108 in the example shown, the device 102 may implement an array of audio subsystems 108 without departing from the scope of the present disclosure, whereby one or more audio subsystems 108 in the array may not physically reside on the device 102, but be in communication with the audio subsystem 108. For example, the device 102 may correspond to a vehicle infotainment system that leverages an array of microphones positioned throughout the vehicle. In the example shown, the user speaks a respective utterance 106 in a natural language of English for the phrase “What is the weather in Chicago?” and the audio subsystem 108 converts the utterance 106 into corresponding acoustic frames 110 for input to the ASR model 200. Thereafter, the ASR model 200 receives, as input, the acoustic frames 110 corresponding to the utterance 106, and generates/predicts, as output, a corresponding transcription 120 (e.g., recognition result/hypothesis) of the utterance 106.

In the example shown, the user device 102 and/or the cloud computing environment 150 also executes a user interface generator 107 configured to present a representation of the transcription 120 of the utterance 106 to the user 104 of the user device 102. In some configurations, the transcription 120 output from the ASR model 200 is processed, e.g., by a natural language understanding (NLU) module executing on the user device 102 or the remote computing device 201, to execute a user command. Additionally or alternatively, a text-to-speech system (e.g., executing on any combination of the user device 102 or the remote system 150) may convert the transcription into synthesized speech for audible output by another device. For instance, the original utterance 106 may correspond to a message the user 104 is sending to a friend in which the transcription 120 is converted to synthesized speech for audible output to the friend to listen to the message conveyed in the original utterance 106.

The remote system 150 (i.e., cloud computing environment 150) may be a single computer, multiple computers, or a distributed system having scalable/elastic resources 152 including computing resources 154 (e.g., data processing hardware) and/or storage resources 156 (e.g., memory hardware). A data store 158 (i.e., a remote storage device) may be overlain on the storage resources 156 to allow scalable use of the storage resources 156 by one or more user device 102 or the computing resources 154. The device 102 may utilize the remote resources 152 to perform various functionality related to automatic speech recognition. For instance, the device 102 is configured to perform speech recognition using the automatic speech recognition model 200. The ASR model 200 may reside on the device 102 (referred to as on-device systems) or reside remotely (e.g., reside on the remote system 150), but in communication with the device 102. In other words, the ASR model 200 may be local, remote, or both in any combination. For instance, when the ASR model 200 is rather large in size or processing requirements, the ASR model 200 may reside in the remote system 150. Yet when the device 102 may support the size or the processing requirements of the ASR model 200, the model 200 may reside on the device 102 using the data processing hardware 111 and/or the memory hardware 113. In some implementations, the ASR model 200 may be a large trained model that resides on a server (i.e., remote system 150) and is further configured with a hierarchical recurrent adapter (HRA) 500 that is trained based on adaptation training data set 610.

In some implementations, the ASR model 200 is augmented with a hierarchical recurrent adapter (HRA) 500 (also referred to herein as recurrent adapter 500) including a controller 510 and a plurality of adapter heads 520. For example, an ASR model 200 may include a base/backbone model that is trained on a large set of user data for a large number of users. The base model portion of the ASR model 200 may then be frozen, and the HRA 500 may then be trained for multi-task adaptation. In other words, the HRA 500 may be trained for one or more tasks/domains such that the ASR model 200 can be adapted/refined for multiple tasks. For example, the ASR model 200 may be trained on a large corpus of spoken utterances representing typical speech. The HRA 500 may then be trained, with the parameters of the ASR model 200 frozen, on an adaptation training data set 610 including utterances from users with atypical speech not represented in the corpus of training utterances used to train the ASR model 200. In this manner, the ASR model 200 can be fine-tuned using the HRA 500 to recognize utterances spoken with atypical speech without retraining or further fine-tuning the ASR model 200.

In some implementations, the HRA 500 is inserted in each layer of the ASR model 200. Here, the HRA 500 includes the same parameters in each layer of the ASR model 200, such that when the parameters are fine-tuned, the parameters of the HRA 500 in each layer of the ASR model 200 remain consistent. By inserting the HRA 500 at each layer of the ASR model 200, the total number of parameters of the HRA 500 is smaller than other techniques that are used to fine-tune large ASR models (such as residual adapters). Thus, because the HRA 500 implements fewer parameters in the training/fine-tuning process, the ASR model 200 is able to be adapted to multiple tasks, using the HRA 500, in a scalable manner.

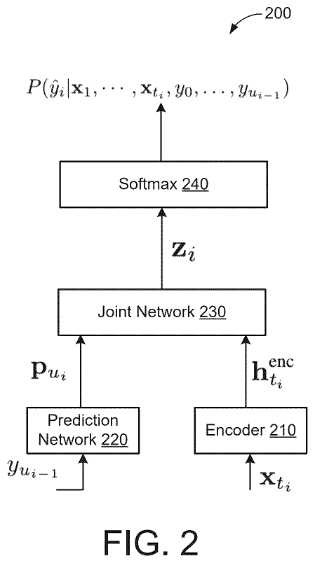

FIG. 2 is a schematic view of an example automatic speech recognition (ASR) model 200. In particular, the ASR model 200 of FIG. 2 includes an example frame alignment-based transducer model including a Recurrent Neural Network-Transducer (RNN-T) model architecture which adheres to latency constraints associated with interactive applications. The use of the RNN-T model architecture is exemplary, and the frame alignment-based transducer model 200 may include other architectures such as transformer-transducer and conformer-transducer model architectures among others. The RNN-T model 200 provides a small computational footprint and utilizes less memory requirements than conventional ASR architectures, making the RNN-T model architecture suitable for performing speech recognition entirely on the user device 102 (e.g., no communication with a remote server is required). The RNN-T model 200 includes an encoder network 210 (interchangeably referred to as an ‘audio encoder 210’), a prediction network 220, and a joint network 230. The encoder network 210, which is roughly analogous to an acoustic model (AM) in a traditional ASR system, includes a stack of self-attention layers (e.g., Conformer or Transformer layers) or a recurrent network of stacked Long Short-Term Memory (LSTM) layers. For instance, the encoder reads a sequence of d-dimensional feature vectors (e.g., acoustic frames 110 (FIG. 1))×=(x₁, x₂, . . . , x_{T}), where xᵢ ∈ [symbol] _{d}, and produces at each output step a higher-order feature representation. This higher-order feature representation is denoted as h₁^{enc}, . . . , h_{T}^{enc}.

Similarly, the prediction network 220 is also an LSTM network, which, like a language model (LM), processes the sequence of non-blank symbols output by a final Softmax layer 240 so far, y₀, . . . , yᵤᵢ₋₁, into a dense representation pᵤ_{ᵢ}. Finally, with the RNN-T model architecture, the representations produced by the encoder and prediction/decoder networks 210, 220 are combined by the joint network 230. The prediction network 220 may be replaced by an embedding look-up table to improve latency by outputting looked-up sparse embeddings in lieu of processing dense representations. The joint network then predicts P(yᵢ|xₜ_{ᵢ}, y₀, . . . , yᵤ_{ᵢ₋₁}), which is a distribution over the next output symbol. Stated differently, the joint network 230 generates, at each output step (e.g., time step), a probability distribution over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 230 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces and/or entire words, in addition to or instead of graphemes. The output distribution of the joint network 230 can include a posterior probability value for each of the different output labels. Thus, if there are 100 different output labels representing different graphemes or other symbols, the output yᵢ of the joint network 230 can include 100 different probability values, one for each output label. The probability distribution can then be used to select and assign scores to candidate orthgraphic elements (e.g., graphemes, wordpieces, and/or words) in a beam search process (e.g., by the Softmax layer 240) for determining the transcription 120.

The Softmax layer 240 may employ any technique to select the output label/symbol with the highest probability in the distribution as the next output symbol predicted by the RNN-T model 200 at the corresponding output step. In this manner, the RNN-T model 200 does not make a conditional independence assumption, rather the prediction of each symbol is conditioned not only on the acoustics but also on the sequence of labels output so far. The RNN-T model 200 does assume an output symbol is independent of future acoustic frames 110, which allows the RNN-T model to be employed in a streaming fashion.

In some examples, the encoder network (i.e., audio encoder) 210 of the RNN-T model 200 includes a stack of self-attention layers/blocks, each including a multi-head self-attention mechanism. Each self-attention layer may include a conformer layer l block. Here, each conformer block includes a series of multi-headed self-attention, depth wise convolution, and feed-forward layers. In some examples, the stack of conformer layers includes a stack of 24 layers having about 600 million parameters. In other examples, the stack of conformer layers includes a stack of 32 layers having about two billion parameters. The prediction network 220 may have two 2,048-dimensional LSTM layers, each of which is also followed by 640-dimensional projection layer. Alternatively, the prediction network 220 may include a stack of transformer or conformer blocks, or a embedding look-up table in lieu of LSTM layers. Finally, the joint network 230 may also have 640 hidden units. The softmax layer 240 may be composed of a unified word piece or grapheme set that is generated using all unique word pieces or graphemes in a plurality of training data sets.

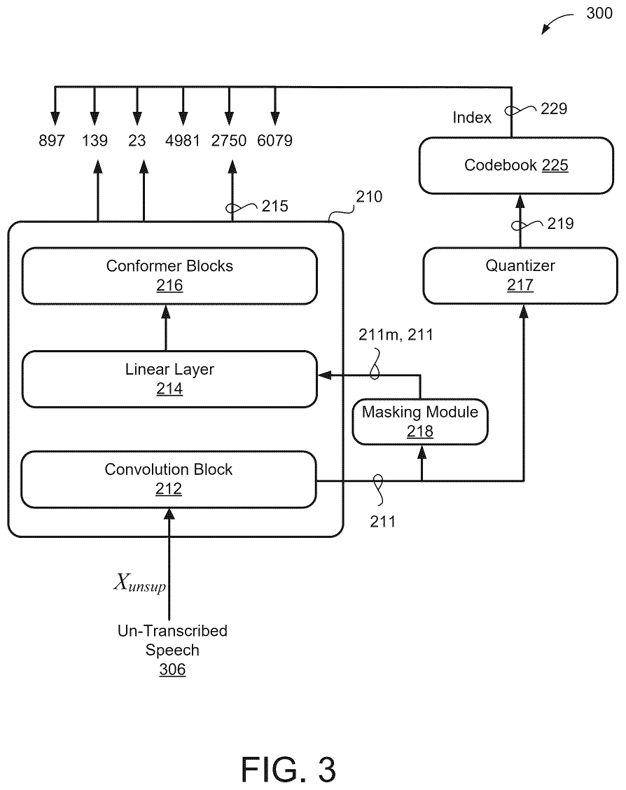

FIG. 3 illustrates an example training process 300 for pre-training the ASR model 200. The training process 300 may pre-train the audio encoder 210 using available pre-training data that includes a set of un-transcribed speech utterances (Xᵤₙₛᵤₚ) 306. Each un-transcribed speech utterance 306 includes audio-only data (i.e., unpaired data) such that the un-transcribed speech utterance 306 is not paired with any corresponding transcription. Further, the un-transcribed speech utterance 306 may include only non-synthetic utterances (e.g., spoken by actual humans), which may be collected, for example, at the client device 102 of FIG. 1. The pre-training process 300 pre-trains the ASR model 200 on the unsupervised/pre-training data that includes the un-transcribed speech utterances (Xᵤₙₛᵤₚ) 306. In the example shown, the pre-training process 300 employs BERT-based Speech pre-training with random projection quantizer (BEST-RQ) for pre-training the audio encoder 210 of the ASR model 200. BEST-RQ is described in “Self-supervised learning with random-projection quantizer for speech recognition,” see Proceedings of Machine Learning Research available at https://proceedings.mlr.press/v162/chiu22a.html.

In some implementations, the audio encoder 210 includes a Conformer encoder including a stack of conformer blocks each of which includes a series of multi-headed self-attention, depth wise convolution, and feed-forward layers. Alternatively, the audio encoder 210 may include another type of encoder having a stack of self-attention layers/blocks, such as a transformer encoder. The Conformer encoder 210 can naturally be split into a feature encoder, including a convolution subsampling block 212, and a context network, including a linear layer 214 and a stack of Conformer blocks 216. In some implementations, the convolution subsampling block 212 has two two-dimensional-convolution layers, both with strides (2, 2), resulting in a 4× reduction in the feature sequence length. The convolution subsampling block 212 receives, as input, a sequence of input features/vectors (e.g., mel-frequency spectrograms such as the acoustic frames 110 of FIG. 1) associated with each un-transcribed speech utterance 306, and generates, as output, for each of a plurality of output steps, an encoded audio feature 211 that corresponds to a respective one of the un-transcribed speech utterances 306.

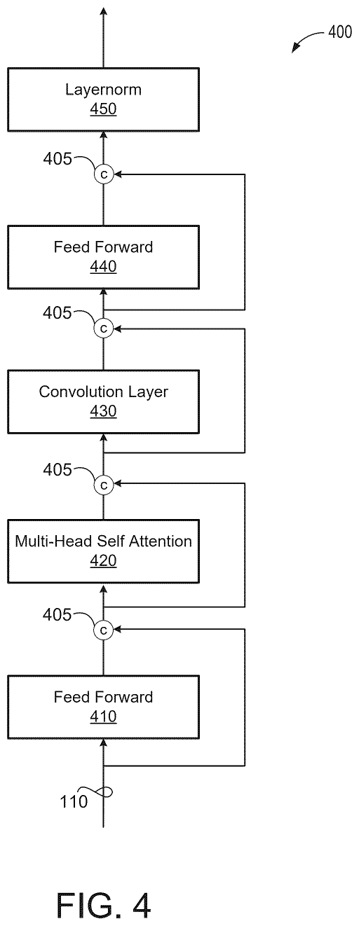

FIG. 4 provides an example of a Conformer block 400 from the stack of Conformer layers of the encoder 210. The Conformer block 400 includes a first half feed-forward layer 410, a second half feed-forward layer 440, with a multi-head self-attention block 420 and a convolution layer 430 disposed between the first and second half feed-forward layers 410, 440, and concatenation operators 405. The first half feed-forward layer 410 processes the input audio data 110 including the input mel-spectrogram sequence. Subsequently, the multi-head self attention block 420 receives the input audio data 110 concatenated with the output of the first half-feed forward layer 410. Intuitively, the role of the multi-head self attention block 420 is to summarize noise context separately for each input frame that is to be enhanced. A convolution layer 430 subsamples the output of the multi-head self attention block 420 concatenated with the output of the first half feed forward layer 410. Thereafter, a second half-feed forward layer 440 receives a concatenation of the convolution layer 430 output and the multi-head self attention block 420. A layernorm module 450 processes the output from the second half feed-forward layer 440. Mathematically, the conformer block 400 transforms input features x, using modulation features m, to produce output features y, as follows:

$$\hat{x} = x + r ( m ) ⊙ x + h ( m ) \qquad ( 1 )$$

$$\tilde{x} = \hat{x} + \frac{1}{2} FFN ( \hat{x} ) , \tilde{n} = n + \frac{1}{2} FFN ( n )$$

$${x}^{′} = \tilde{x} + Conv ( \tilde{x} ) , {n}^{′} = \tilde{n} + Conv ( \tilde{n} )$$

$${x}^{″} = {x}^{′} + MHCA ( {x}^{′} , {n}^{′} )$$

$${x}^{′′′} = {x}^{′} ⊙ r ( {x}^{″} ) + h ( {x}^{″} )$$

$${x}^{′′′′} = {x}^{′} + MHCA ( {x}^{′} , {x}^{′′′} )$$

$$y = LayerNorm ( {x}^{′′′′} + \frac{1}{2} FFN ( {x}^{′′′′} ) )$$

Referring back to FIG. 3, the encoded audio features 211 (i.e., interchangeably referred to as “encoded features 211”) output from the convolution subsampling block 212 may be fed to a masking module 218 where some of the encoded features 211 are randomly chosen and replaced with a trained feature vector shared between all masked time steps to provide corresponding masked encoded features 211, 211m. In some examples, the masking module 218 masks the randomly chosen encoded features 211 for masking by randomly sampling without replacement a certain proportion p of all time steps to be start indices and then masks the subsequent M consecutive time steps from every sample index, whereby some spans may overlap. After masking is applied, the linear layer 214 and the Conformer blocks 216 of the context network receives the masked encoded features 211m (or encoded features 211 not chosen by the masking module 218) and outputs corresponding contrastive context vectors (i.e., encoded representation) 215 from masked encoded features 211m. Moreover, a quantizer 217 receives the encoded features 211 as input, and applies random projections to generate, from the encoded features 211, quantized vectors (i.e., target context vectors) 219 as output. The quantizer 217 projects the target context vectors 219 to a randomly initialized codebook 225 that maps the target context vectors 219 to discrete labels 229 through finding a nearest vector in the codebook 225. Notably, the quantizer 217 includes a random-projection quantizer 217 configured to randomly initialize a matrix and the codebook 225. The random-projection quantizer 217 uses the matrix to project the input encoded features 211 into the target context vectors 219 and uses the codebook 225 to find a nearest vector where an index of the vector includes the label 229. The pre-training process 300 may add a softmax layer on top of the audio encoder 210 to learn to predict the quantized speech labels 229.

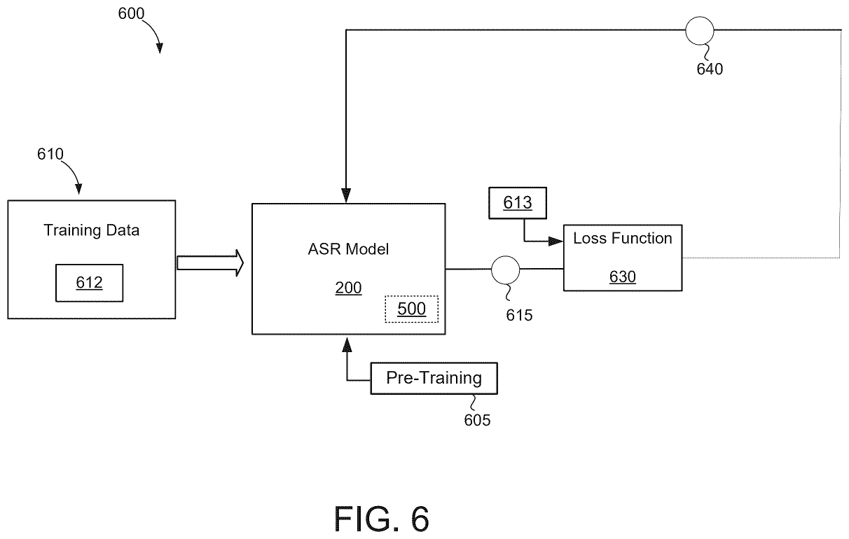

The pre-training process 300 trains the audio encoder 210 to predict the labels 229 for each of the corresponding contrastive context vectors (i.e., encoded representation) 215 at the masked positions. Notably, both the randomly initialized matrix and the codebook may be fixed during the pre-training part 300. Once the ASR model 200 is pre-trained, the parameters of the ASR model 200 may be frozen. In turn, when adapting the ASR model 200 using a hierarchical recurrent adapter (HRA) 500, only parameters of the HRA 500 are adjusted during training, as discussed in greater detail below (FIG. 6).

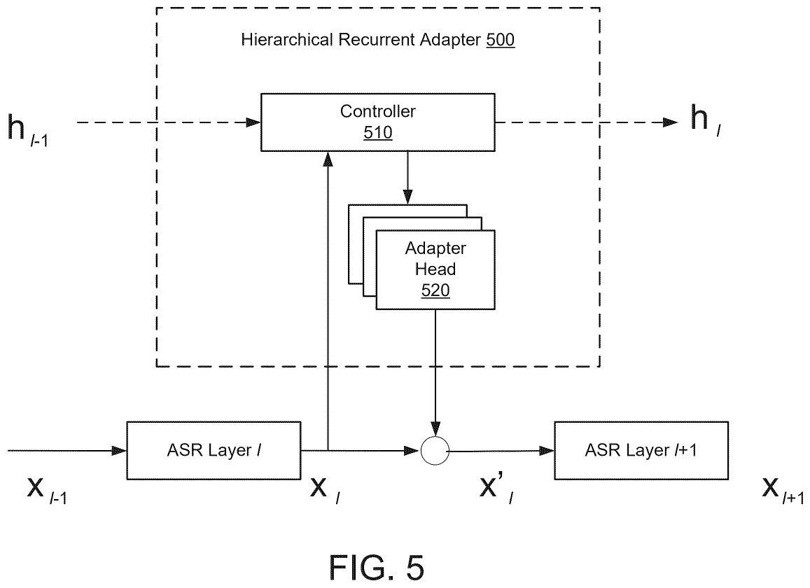

FIG. 5 is a schematic view of an example hierarchical recurrent adapter (HRA) 500. The HRA 500 may include a single recurrent controller 510 and multiple task-level adapter heads 520. In some implementations, the controller 510 and the adapter heads 520 are inserted into each layer of the ASR model 200. For example, the HRA may be inserted in some or all of the layers of the ASR model 200 described in FIGS. 2-4. The shared controller 510 may be responsible for interacting with task specialized adapter heads 520. To adapt the ASR model 200, the output of the adapter head 520 is added to the backbone feature (i.e., output of a layer of the ASR model 200) for adaptation of downstream speech tasks. Unlike residual adapters the HRA 500 is shared across all layers of a pre-trained ASR model 200 to keep adapter parameters scalable. In other words, the adapter heads 520 and the recurrent controller 510 weights are shared across all layers of the ASR model 200, keeping the adapter parameter overhead minimal.

In some implementations, each adapter head 520 corresponds to a single task. In other words, each adapter head 520 is responsible for adapting the large pre-trained ASR model 200 to a specific task. For example, each adapter head 520 may correspond to a specific individual, such that the ASR model can be adapted to a number of unique speakers. In another example, each adapter head 520 may correspond to a specific domain, such as a speech type. In this example, one adapter head 520 corresponds to users with accented speech, while another adapter head corresponds to users with dysarthric speech, etc. In this way, a large ASR model 200 trained using utterances of users with typical speech can be adapted, using the HRA 500, to atypical speech (accented speech, dysarthric speech, deaf speech, etc.), speech in another language, or to any other domain without having to retrain the ASR model 200. In some implementations, a one-hot vector (or one-hot embedding) can be used to activate a particular adapter head 520 based on the utterance. For example, The HRA 500 detects a particular task/domain based on a current speech utterance received by the ASR model 200. The HRA 500 may then activate a corresponding adapter head 520. The one-hot embedding may be trained when training the HRA 500.

The controller 510 may be shared for all layers of the underlying ASR model 200 as well as tasks and is responsible for orchestrating the interaction between the ASR model 200 and task specialized adapter heads 520. The controller 510 takes in, as input, the activation xₗ at layer l of the backbone ASR model 200 and computes a new interaction recurrent vector hₗ for task-level adapter head 520. In some implementations, the controller 510 is be a recurrent network, and also takes in its last hidden activation hₗ₋₁.

In some implementations, the adapter controller 510 is parameterized with a lightweight recurrent network for parameter and inference efficiency. Specifically, the adapter controller 510 may include IndRNN as it is computationally cheaper than the other RNN variants and admits ReLU function as its activation without a gradient explosion issue. Here, IndRNN computes its recurrent activation hₗ as:

$${h}_{l} = ReLU ( {Wx}_{l} + {uh}_{l - l} + b ) \qquad ( 2 )$$

where xₗ is the RNN input feature representation extracted from the l^{th} layer of the backbone speech model and W, u and b are input projection matrix, recurrent scaling vector, and the bias term, respectively.

Here, once the new interaction recurrent vector hₗ is computed (as in Eq. (2)) the adapter head 520 produces an adapter output or for backbone layer l by passing the output through the task-level adapter head 520. The adapter output or is then added back to the original feature activation to obtain task-specific representation x′ₗ:

$${x}_{l}^{′} = {x}_{l} + {o}_{l} . \qquad ( 3 )$$

The resulting representation x′ₗ may then be given as input to the next backbone layer l+1.

Similar to the controller 510, the task adapter head 520 is also shared across the layers of the ASR model 200 resulting in a compact hierarchical recurrent adapter 500 for all tasks. The adapter head 520 may include a linear project matrix and/or a 2-layer FFN. For example, the adapter head 520 may implement a simple linear projection matrix as task-level memory. In this example, adapting the HRA 500 to a new task includes fine-tuning only a single linear projection matrix. Given the controller hidden state hₗ the linear projection head then computes the output oₗ as:

$${o}_{l} = {M}_{n} {h}_{l} \qquad ( 4 )$$

where Mₙ is the task-specific project matrix and n is the task index.

In other implementations, the adapter head 520 includes a 2-layer Feed Forward (FF) neural network with ReLU activation as the task-level adapter head 520. In these implementations, the adapter output is computed as:

$${o}_{t} = {M}_{2 , n} ReLU ( {M}_{1 , n} {h}_{t} ) \qquad ( 5 )$$

where M_{2,n} and M_{1,n} are the task-level head weights for the nth task.

FIG. 6 illustrates a training process 600 for adapting a pre-trained ASR model 200 with a hierarchical recurrent adapter (HRA) 500 for multi-task adaptation. In some implementations, the process 600 employs a two-step training technique. First, the ASR model 200 is pre-trained on an initial training data set 605 including spoken utterances from a large pool of speakers to obtain a backbone ASR model 200. The pre-training process is described in greater detail above (FIG. 3). The next step of the two-step training technique involves training the HRA 500 on adaptation training data 610, while the parameters of the backbone ASR model 200 are frozen. The result is an ASR model 200 that is adapted, by the HRA 500, to process speech in one or more domains.

The process 600 starts with pre-training the ASR model 200 using pre-training data 605 (i.e., initial training data 605). Pre-training a model is a technique used for initializing a model which can then be further fine-tuned based on additional training data 610. For the ASR model 200, pre-training may include initiating the ASR model 200 using typical speech. In some implementations, the pre-training data 605 does not include utterances 612 that are included in the adaptation training data 610. In some implementations, the ASR model 200 includes a Universal Speech Model (USM) including 2 billion parameters. In these implementations, the ASR model 200 may be pre-trained with the BEST-RQ objective on large unlabeled multilingual corpora of 12 million hours covering over 300 languages. We then apply different adapter techniques to the pre-trained USM model for adaptation of ASR tasks. The adapter methods as well as full model fine-tuning baseline are trained by using the CTC loss for ASR.

The process 600 can then adapt the ASR model 200 to different tasks/domains. In particular, the process 600 trains the HRA 500 using training data 610 to fine-tune one or more adapter heads 520 of the HRA 500, while the parameters of the ASR model 200 are frozen after pre-training. That is, while the ASR model 200 is used to generate output 615 based on the input utterance 612, only the HRA 500 is optimized based on the determined loss 640.

The training process 600 may include fine-tuning any of the components 510, 520 of the HRA 500 separately or jointly in any suitable combination. In some implementations, the training process 600 also includes training a one-hot embedding used to activate a corresponding adapter head 520 in response to a respective task. The process 600 includes feeding a training input 610 to the ASR model 200. In some implementations, the training input 610 includes a plurality of spoken utterances 612, each spoken utterance 612 including a corresponding label 613 (e.g., a transcription of the spoken utterance 612. The training data 610 may include corresponding sequences of phonemes and graphemes. In some implementations, the training data set 610 is completely different from the initial training data 605. For example, the initial training data 605 may include utterances spoken by users with typical speech, and the training data set 610 may include utterances spoken by users with atypical speech. This allows the backbone ASR model 200 to be trained on a wider variety of pre-training data 605 while the adaptation using the HRA 500 can be trained on tasks having a significantly smaller set of training data 610.

In some implementations, the adaptation training data 610 is used to adapt the HRA 500 to a single task and includes anonymized English utterances from domains including voice search, far-field and long-form. The corresponding labels 613 include speech transcripts contain a mix of human-transcribed labels and machine-transcribed labels produced by teacher ASR models. In other implementations, the adaptation training data 610 includes utterances spoken by speakers with speech impairments from the dysarthric speech corpus, including speakers with ALS, Down-Syndrome, Cerebral Palsy, Parkinson's Stroke, and other etiologies.

Upon receiving the training input 610, the ASR model 200, augmented with the HRA 500, may generate an output 615 (e.g., a probability distribution over possible speech recognition hypotheses). The ASR model 200 may process the utterance 612 in the manner described with respect to any of FIGS. 1-4 or any other suitable manner for automatic speech recognition. Further, in training the HRA 500, the ASR model may be augmented with the HRA 500. In particular, the HRA 500 may be inserted in some or all of the layers of the ASR model 200.

In some implementations, the output 615 is used by a loss function 630 to generate a loss 640. That is, the loss function 630 compares the output 615 and the label 613 to generate the loss 640, where the loss 640 indicates a discrepancy between the label 613 corresponding to a transcript of the spoken utterance 612 and the output 615. The loss function 630 may implement any suitable technique to determine a loss such as regression loss, mean squared error, mean squared logarithmic error, mean absolute error, binary classification, binary cross entropy, hinge loss, multi-class loss, etc.

The loss 640 may then be fed directly to the ASR model 200. Here, the ASR model 200 is frozen and thus processing the loss 640 includes adjusting only one or more parameters of the HRA 500 (i.e., the adapter heads 520) to account for the loss 540. In some implementations, the HRA 500 includes an embedding used for activating adapter heads 520 of the HRA 500. For example, the embedding may be extracted from a reference mel spectrogram of the speaker and/or adapting an embedding, from a table of speaker embeddings, that most closely resembles a timbre of the speaker of the utterance. Here, optimizing the HRA includes optimizing the embedding.

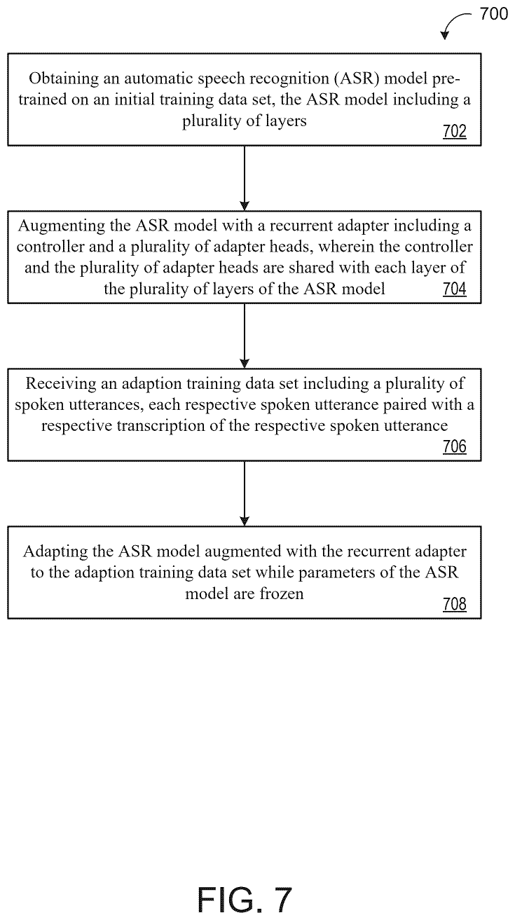

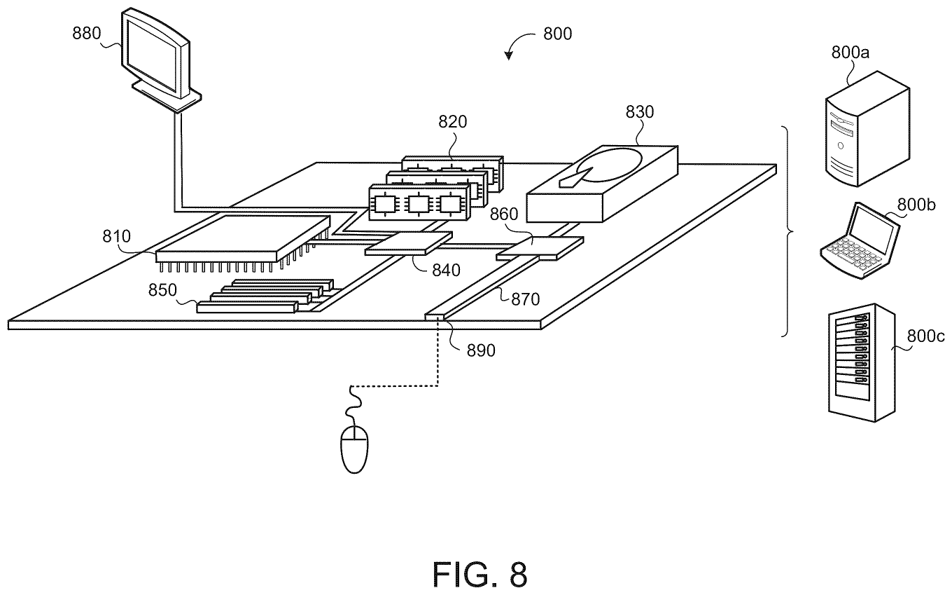

FIG. 7 is a flowchart of an exemplary arrangement of operations for a computer-implemented method 700 of implementing hierarchical recurrent adapters for efficient multi-task adaptation of large speech models. The method 700 may be performed, for example, by various elements of the example speech environment 100 of FIG. 1 and/or the computing device 800 of FIG. 8. At operation 702, the method 700 includes obtaining an automatic speech recognition (ASR) model 200 pre-trained on an initial training data set, the ASR model 200 including a plurality of layers. At operation 704, the method 700 includes augmenting the ASR model 200 with a recurrent adapter 500 including a controller 510 and a plurality of adapter heads 520, wherein the controller 510 and the plurality of adapter heads 520 are shared with each layer of the plurality of layers of the ASR model 200. At operation 706, the method 700 includes receiving an adaptation training data set 610 including a plurality of spoken utterances 612, each respective spoken utterance 612 of the plurality of spoken utterances 612 in the adaptation training data set 610 is paired with a respective transcription 613 of the respective spoken utterance 612. At operation 708, the method 700 includes adapting the ASR model 200 augmented with the recurrent adapter 500 to the adaptation training data set 610 while parameters of the ASR model 200 are frozen.

FIG. 8 is a schematic view of an example computing device 800 that may be used to implement the systems and methods described in this document. The computing device 800 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 800 includes a processor 810, memory 820, a storage device 830, a high-speed interface/controller 840 connecting to the memory 820 and high-speed expansion ports 850, and a low speed interface/controller 860 connecting to a low speed bus 870 and a storage device 830. Each of the components 810, 820, 830, 840, 850, and 860, are interconnected using various busses, and may be mounted on a common motherboard or in other manners as appropriate. The processor 810 can process instructions for execution within the computing device 800, including instructions stored in the memory 820 or on the storage device 830 to display graphical information for a graphical user interface (GUI) on an external input/output device, such as display 880 coupled to high speed interface 840. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 820 stores information non-transitorily within the computing device 800. The memory 820 may be a computer-readable medium, a volatile memory unit(s), or non-volatile memory unit(s). The non-transitory memory 820 may be physical devices used to store programs (e.g., sequences of instructions) or data (e.g., program state information) on a temporary or permanent basis for use by the computing device 800. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 830 is capable of providing mass storage for the computing device 800. In some implementations, the storage device 830 is a computer-readable medium. In various different implementations, the storage device 830 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 820, the storage device 830, or memory on processor 810.

The high speed controller 840 manages bandwidth-intensive operations for the computing device 800, while the low speed controller 860 manages lower bandwidth-intensive operations. Such allocation of duties is exemplary only. In some implementations, the high-speed controller 840 is coupled to the memory 820, the display 880 (e.g., through a graphics processor or accelerator), and to the high-speed expansion ports 850, which may accept various expansion cards (not shown). In some implementations, the low-speed controller 860 is coupled to the storage device 830 and a low-speed expansion port 890. The low-speed expansion port 890, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 800a or multiple times in a group of such servers 800a, as a laptop computer 800b, or as part of a rack server system 800c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method when executed by data processing hardware causes the data processing hardware to perform operations comprising:
obtaining an automatic speech recognition (ASR) model pre-trained on an initial training data set, the ASR model comprising a plurality of layers;
augmenting the ASR model with a recurrent adapter comprising a controller and a plurality of adapter heads, wherein the controller and the plurality of adapter heads are shared with each layer of the plurality of layers of the ASR model;
receiving an adaptation training data set comprising a plurality of spoken utterances, each respective spoken utterance of the plurality of spoken utterances in the adaptation training data set is paired with a respective transcription of the respective spoken utterance; and
adapting the ASR model augmented with the recurrent adapter to the adaptation training data set while parameters of the ASR model are frozen.

2. The method of claim 1, wherein each adapter head of the plurality of adapter heads comprises a simple linear projection matrix architecture.

3. The method of claim 1, wherein each adapter head of the plurality of adapter heads comprises a feed-forward network (FFN) architecture.

4. The method of claim 1, wherein each spoken utterance of the plurality of spoken utterances of the adaptation training data set is spoken by a speaker with atypical speech.

5. The method of claim 1, wherein a number of the plurality of spoken utterances in the adaptation training data set is less than a number of utterances in the initial training data set used to pre-train the ASR model.

6. The method of claim 1, wherein the initial training data set comprises a set of un-transcribed speech utterances.

7. The method of claim 6, wherein the ASR model is pre-trained on the set of un-transcribed speech utterances using BERT-based Speech pre-training with random projection quantizer (BEST-RQ).

8. The method of claim 7, wherein the speech utterances in the set of un-transcribed speech utterances comprise multilingual speech utterances.

9. The method of claim 1, wherein the adaptation training data set comprises anonymized utterances in a single language.

10. The method of claim 1, wherein augmenting the ASR model with the recurrent adapter further comprises inserting the controller and the plurality of adapter heads of the recurrent adapter into each layer of the ASR model.

11. A system comprising:
data processing hardware; and
memory hardware in communication with the data processing hardware, the memory hardware storing instructions that when executed on the data processing hardware cause the data processing hardware to perform operations comprising:
obtaining an automatic speech recognition (ASR) model pre-trained on an initial training data set, the ASR model comprising a plurality of layers;
augmenting the ASR model with a recurrent adapter comprising a controller and a plurality of adapter heads, wherein the controller and the plurality of adapter heads are shared with each layer of the plurality of layers of the ASR model;
receiving an adaptation training data set comprising a plurality of spoken utterances, each respective spoken utterance of the plurality of spoken utterances in the adaptation training data set is paired with a respective transcription of the respective spoken utterance; and
adapting the ASR model augmented with the recurrent adapter to the adaptation training data set while parameters of the ASR model are frozen.

12. The system of claim 11, wherein each adapter head of the plurality of adapter heads comprises a simple linear projection matrix architecture.

13. The system of claim 11, wherein each adapter head of the plurality of adapter heads comprises a feed-forward network (FFN) architecture.

14. The system of claim 11, wherein each spoken utterance of the plurality of spoken utterances of the adaptation training data set is spoken by a speaker with atypical speech.

15. The system of claim 11, wherein a number of the plurality of spoken utterances in the adaptation training data set is less than a number of utterances in the initial training data set used to pre-train the ASR model.

16. The system of claim 11, wherein the initial training data set comprises a set of un-transcribed speech utterances.

17. The system of claim 16, wherein the ASR model is pre-trained on the set of un-transcribed speech utterances using BERT-based Speech pre-training with random projection quantizer (BEST-RQ).

18. The system of claim 17, wherein the speech utterances in the set of un-transcribed speech utterances comprise multilingual speech utterances.

19. The system of claim 11, wherein the adaptation training data set comprises anonymized utterances in a single language.

20. The system of claim 11, wherein augmenting the ASR model with the recurrent adapter further comprises inserting the controller and the plurality of adapter heads of the recurrent adapter into each layer of the ASR model.
